(19) United States
(12) Patent Application Publication
(10) Pub. No.: US 2018/0109127 A1
(43) Pub. Date: Apr. 19, 2018

(54) TRANSMISSION CABLE STRUCTURE

(71) Applicant: Nyquest Corporation Limited, Hsinchu City (TW)

(72) Inventor: Ying-Jie HUANG, Hsinchu City (TW)

(73) Assignee: Nyquest Corporation Limited, Hsinchu City (TW)

(21) Appl. No.: 15/722,530

(22) Filed: Oct. 2, 2017

(30) Foreign Application Priority Data
Oct. 14, 2016 (TW) 105215698

(51) Int. Cl. H02J 7/00; H01R 13/717; G06F 1/26

(52) U.S. Cl. CPC H02J 7/0052; H02J 2007/0062; G06F 1/266; H01R 13/7175

(57) ABSTRACT

A transmission cable structure includes a cable, a first connector, a second connector, a control circuit and a light-emitting circuit. The cable includes at least one conducting wire installed therein. The first connector includes a body portion and a connecting portion. The body portion connects with an end of the cable, while the second connector connects with another end of the cable. The control circuit is configured within the body portion. The control circuit electrically connects with the conducting wire, and generates a light-emitting signal according to an equivalent capacitance value of the conducting wire. The light-emitting circuit is configured within the body portion. The light-emitting circuit couples with the control circuit and emits light according to the light-emitting signal.

### CROSS-REFERENCE TO RELATED APPLICATION

This non-provisional application claims priority under 35 U.S.C. § 119(a) to Patent Application No. 105215698 filed in Taiwan, R.O.C. on Oct. 14, 2016, the entire contents of which are hereby incorporated by reference.

### BACKGROUND

### Related Field

The instant disclosure relates to a transmission cable structure, in particular, to a transmission cable structure capable of emitting light.

### Related Art

Universal Serial Bus (USB) is a technical standard for input/output interface with a variety of applications, such as USB transmission cable. An USB transmission cable includes a power-end connector and a device-end connector. The power-end connector is connectable to a power apparatus, such as a transformer or a computer. The device-end connector is connectable to a powered device, such as a camera, mobile phone, tablet or personal digital assistant (PDA). Take a personal computer and a mobile phone as examples for the power apparatus and the powered device. When the two connectors mentioned above connect with the personal computer and the mobile phone respectively, the USB transmission cable not only transmits the electricity from the personal computer to the mobile phone, but also transmits the data stored on the mobile phone to the computer. Therefore, using the USB transmission cable is quite convenient as it is capable of transmitting both electricity and data.

However, if the USB transmission cable is installed in a low-light environment, it would be difficult for the user to find the device-end connector. Even though the device-end connector is found, the device-end connector still cannot be precisely inserted into the connection port of the powered device. For example, the user may not be able to recognize the front or back side of the device-end connector in the dark, and needs to try more times to inset the device-end connector into the powered device successfully. If the user does not recognize correctly, the USB transmission cable would not function normally.

### SUMMARY

Accordingly, a transmission cable structure is introduced in the embodiments of the instant disclosure.

In an embodiment, a transmission cable structure includes a cable, a first connector, a second connector, a control circuit and a light-emitting circuit. The cable includes at least one conducting wire installed therein. The first connector includes a body portion and a connecting portion. The body portion connects with an end of the cable, while the second connector connects with another end of the cable. The control circuit is configured within the body portion. The control circuit electrically connects with the conducting wire, and generates a light-emitting signal according to an equivalent capacitance value of the conducting wire. The light-emitting circuit is configured within the body portion. The light-emitting circuit is coupled to the control circuit and emits light according to the light-emitting signal.

In an embodiment, the cable comprises a light-guiding strip. The light-guiding strip connects with the light-emitting circuit, and the light-guiding strip extends from the first connector to the second connector.

In an embodiment, the first connector, the cable and the second connector comprise light-transmissible material.

In an embodiment, the control circuit generates the light-emitting signal when the equivalent capacitance value of the conducting wire is greater than a preset capacitance value.

In an embodiment, the control circuit comprises a charging/discharging circuit, a counter and a comparator. The charging/discharging circuit is coupled to the conducting wire. The charging/discharging circuit charges and discharges according to the equivalent capacitance value of the conducting wire. The counter counts a number of charging/discharging times of the charging/discharging circuit to generate a count value. The comparator compares the count value with a predetermined value to generate the light-emitting signal.

In an embodiment, the first connector connects with a power apparatus via the connecting portion, and the second connector connects with a powered device.

In an embodiment, the first connector connects with a powered device via the connecting portion, and the second connector connects with a power apparatus.

In an embodiment, the light-emitting circuit emits light sustainingly within a preset period, or emits light intermittently within the preset period.

In brief, according to the embodiments of the instant disclosure, a transmission cable structure includes a control circuit and a light-emitting circuit within a connector at an end thereof. When the user touches a cable thereof or connectors at two ends of the cable, the control circuit enables the light-emitting circuit to emit light. Therefore, even in a low-light environment, the user can still use the light source mentioned above to find the device-end connector, and precisely insert the device-end connector into the corresponding connection port of the electronic device, thereby improving the usability of the transmission cable structure.

### BRIEF DESCRIPTION OF THE DRAWINGS

The disclosure will become more fully understood from the detailed description given herein below for illustration only, and thus not limitative of the disclosure, wherein:

FIG. 1 illustrates an explanatory perspective view of a transmission cable structure according to an embodiment of the instant disclosure;

FIG. 2 illustrates an explanatory diagram regarding an operating status of the transmission cable structure in FIG. 1;

FIG. 3 illustrates an explanatory structural diagram regarding an embodiment of a first connector of the transmission cable structure in FIG. 1;

FIG. 4 illustrates an explanatory diagram regarding another embodiment of the first connector of the transmission cable structure in FIG. 1; and

FIG. 5 illustrates a block diagram regarding an embodiment of a control circuit in FIG. 3 and FIG. 4.

### DETAILED DESCRIPTION

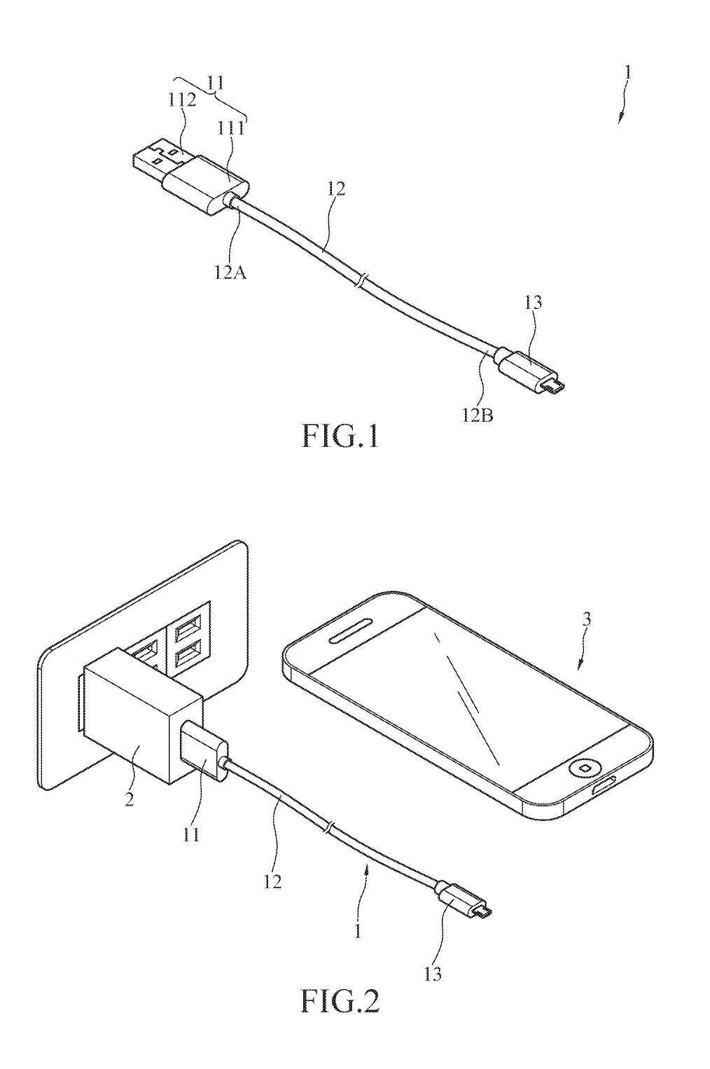

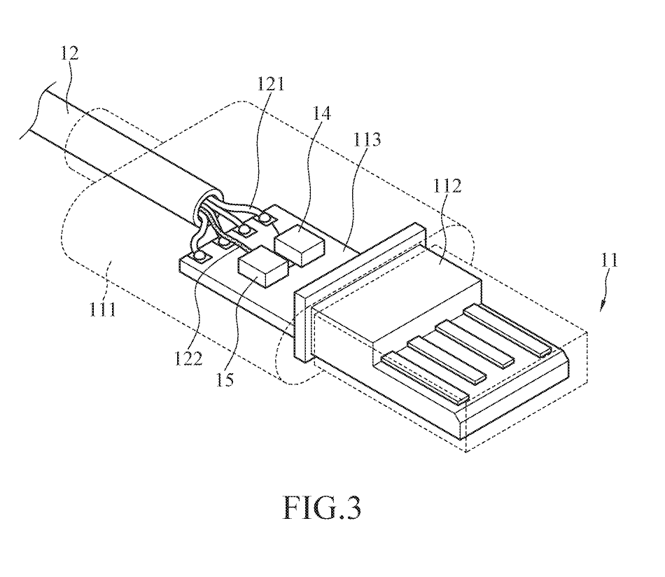

Please refer to FIG. 1, which illustrates an explanatory perspective view of a transmission cable structure according to an embodiment of the instant disclosure. FIG. 2 illustrates an explanatory diagram regarding an operating status of the transmission cable structure in FIG. 1. FIG. 3 illustrates an explanatory structural diagram regarding an embodiment of a first connector of the transmission cable structure in FIG. 1. Here in FIGS. 1 to 3, a transmission cable structure 1 is disclosed as an example for the USB transmission cable, while a first connector 11 and a second connector 13 are examples for the power-end connector and the device-end connector respectively.

Please jointly refer to FIGS. 1 to 3. The transmission cable structure 1 includes the first connector 11, a cable 12, the second connector 13, a control circuit 14 and a light-emitting circuit 15. A first end 12A of the cable 12 connects with the first connector 11, a second end 12B of the cable 12 connects with the second connector 13.

As shown in FIG. 3, the interior of the cable 12 is installed with at least one conducting wire 121. The conducting wire 121 may be realized by either the power wire, data wire or ground wire of the USB transmission cable, none of which should become a limitation to the instant disclosure. The conducting wire 121 extends between the first connector 11 and the second connector 13 to transmit electricity and data between the first connector 11 and the second connector 13.

The first connector 11 includes a body portion 111 and a connecting portion 112. The body portion 111 connects with the first end 12A of the cable 12. The control circuit 14 and the light-emitting circuit 15 are configured within the body portion 111. As shown in FIG. 2, the connecting portion 112 of the first connector 11 is insertable into a power apparatus 2, such as inserted into an USB port of a transformer or computer, so that the connecting portion 112 is able to receive the electricity from the transformer or computer.

The control circuit 14 herein may be coupled to a power wire of the connecting portion 112 to support the electricity required upon operation of the control circuit 14. The control circuit 14 connects with the conducting wire 121 of the cable 12. The conducting wire 121 has an equivalent capacitance value. The control circuit 14 generates a light-emitting signal according to the equivalent capacitance value of the conducting wire 121. The light-emitting circuit 15 is coupled to the control circuit 14 and receives the light-emitting signal generated from the control circuit 14. The light-emitting circuit 15 emits light according to the light-emitting signal. In practice, the light-emitting circuit 15 includes a light emitting diode (LED).

In some embodiments, the control circuit 14 is able to detect if the equivalent capacitance value of the conducting wire 121 has changes. When such a changes is greater than a predetermined value, it means the conducting wire 121 is touched by an object, or some object is moving close to the conducting wire 121 and cause the changes of the equivalent capacitance value of the conducting wire 121. In the meantime, the control circuit 14 enables the light-emitting circuit 15 to emit light.

Accordingly, comparing to the prior art, even though the transmission cable structure 1 is located in a low-light environment, with the conducting wire 121 extending between the first connector 11 and the second connector 13, as long as the user 5 touches any portion of the first connector 11, the cable 12 or the second connector 13, or the user is close enough to any portion of the first connector 11, the cable 12 or the second connector 13, the control circuit 14 detects the change of the equivalent capacitance value of the conducting wire 121 and enables the light-emitting circuit 15 to emit light as a light source. Therefore, the user is able to find the second connector 13 at the device-end via the light source generated at the power-end, and relying on the light source, to insert the second connector 13 into a corresponding connection port of an electronic device and transmit data or electricity.

In practice, the given example in FIG. 3 is to weld the control circuit 14 and the light-emitting circuit 15 respectively on a same surface of a circuit board 113 within the body portion 111. However, such practice should not become a general limitation to the instant disclosure. The control circuit 14 and light-emitting circuit 15 may be welded on different surfaces of the circuit board 113.

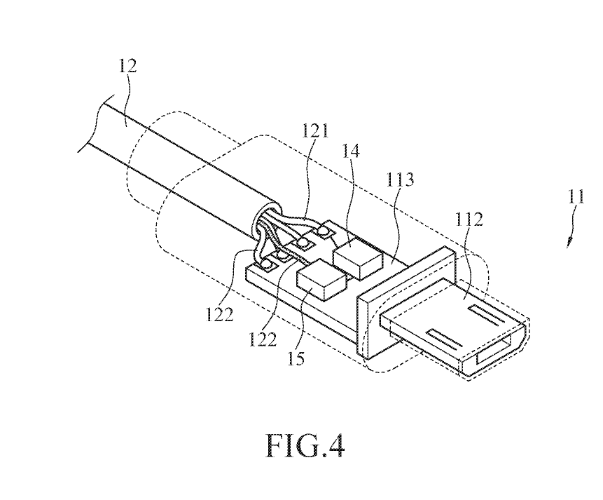

FIG. 4 illustrates an explanatory diagram regarding another embodiment of the first connector of the transmission cable structure in FIG. 1. In this embodiment shown in FIG. 4, the first connector 11 may be configured as a device-end connector, namely, the control circuit 14 and light-emitting circuit 15 may also be configured within the device-end connector. The conducting wire 121 herein may be the power wire, and the control circuit 14 is coupled to the conducting wire 121 to receive and operate with the electricity from the power-end connector (namely the second connector 13). When the equivalent capacitance value of the conducting wire 121 changes, the light-emitting circuit 15 emits light at the device-end connector, so that the user is able to find the device-end connector according to the position of the emitted light source, and to connect the powered device 3. In another embodiment, if the conducting wire 121 is not a power wire, the control circuit 14 further connects to the power wire to receive the electricity from the power-end connector.

In some embodiments, the light-emitting circuit 15 emits light sustainingly within a preset period, such as 15 seconds. The user may touch the transmission cable structure 1 every 15 seconds to keep the light-emitting circuit sustainingly emitting light without continuously touching the transmission cable structure 1. Hence the user has sufficient time to connect the second connector 13 with the powered device 3. In another embodiment, the light-emitting circuit 15 emits light intermittently within the preset period. In addition, the duration of the preset period is increasable and reducible, depending on the actual needs.

In some embodiments, as shown in FIG. 3 and FIG. 4, the cable 12 includes a light-guiding strip 122 installed therein. The amount of the light-guiding strip 122 is adjustable according to the actual needs. The light-guiding strip 122 may be made of optical fiber. The light-guiding strip 122 connects with the light-emitting circuit 15 to transmit the light generated from the light-emitting circuit 15. The light-guiding strip 122 extends from the first connector 11 to the second connector 13. The light-guiding strip 122 transmits the light from the first connector 11 to the second connector 13. The connecting portion 112 of the first connector 11, the cable 12 and the second connector 13 herein may include light-transmissible material respectively. Thus, the light generated from the light-emitting circuit 15 is able to pass outward through the first connector 11, the cable 12 and the second connector 13 without being blocked, and to provide a more sufficient light source for the user.

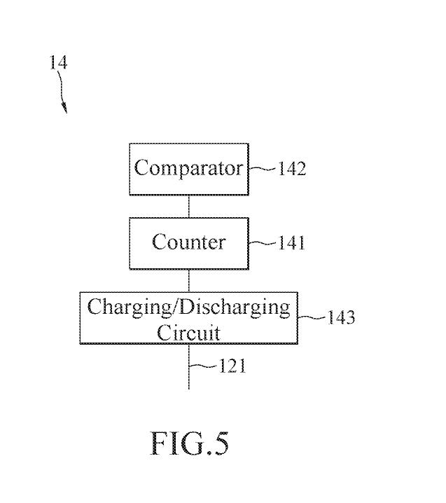

FIG. 5 illustrates a block diagram regarding an embodiment of a control circuit in FIG. 3 and FIG. 4. In practice, referring to FIG. 5, the control circuit 14 may includes a counter 141, a comparator 142 and a charging/discharging circuit 143. The charging/discharging circuit 143 is coupled to the conducting wire 121. The counter 141 is coupled between the charging/discharging circuit 143 and the comparator 142. The charging/discharging circuit 143 conducts real-time charging or discharging according to the equivalent capacitance value of the conducting wire 121. The counter 141 counts a number of charging/discharging times of the charging/discharging circuit 143 within a preset period to output a count value. The comparator 142 is coupled to the counter 141 to receive the count value generated from the counter 141. The comparator 142 compares the count value and a predetermined value. The predetermined value corresponds to an amount of charging/discharging times that corresponds to a preset capacitance value, so as to determine if the equivalent capacitance value of the conducting wire 121 changes, as well as if an object is close to the conducting wire 121. For example, if the predetermined value is 500, when the count value is smaller than 500, such as 472, it means the conducting wire 121 is touched with its equivalent capacitance value being increased, causing the charging/discharging times of the charging/discharging circuit 143 within a same period to be reduced. Therefore, the comparator 142 compares the count value and the predetermined value, and then outputs the light-emitting signal at high voltage level, which enabling the light-emitting circuit 15 to emit light.

Accordingly, based on the embodiments of the instant disclosure, a control circuit and a light-emitting circuit are configured within a connector at an end of a transmission cable structure. When the user touches a cable thereof or connectors at two ends of the cable, the control circuit enables the light-emitting circuit to emit light as a light source. Therefore, even in a low-light environment, the user can still use the light source mentioned above to find the device-end connector, and precisely insert the device-end connector into the corresponding connection port of the electronic device, thereby improving the usability of the transmission cable structure.

While the instant disclosure has been described with respect to a limited number of embodiments, those skilled in the art, having benefit of the above description, will appreciate that other embodiments may be devised which do not depart from the scope of the instant disclosure as described herein. In addition, it should be noted that the language used in the instant disclosure has been principally selected for readability and instructional purposes, and may not have been selected to delineate or circumscribe the inventive subject matter. Accordingly, the embodiments of the instant disclosure introduced herein are intended to be illustrative, but not limiting, of the scope of the instant disclosure, which is set forth in the claims.

What is claimed is:

1. A transmission cable structure, comprising:
a cable, having at least one conducting wire installed therein;
a first connector, including a body portion and a connecting portion, the body portion connecting with an end of the cable;
a second connector, connecting with another end of the cable;
a control circuit, configured within the body portion, the control circuit electrically connecting with the conducting wire, and generating a light-emitting signal according to an equivalent capacitance value of the conducting wire; and
a light-emitting circuit, configured within the body portion, the light-emitting circuit being coupled to the control circuit to emit light according to the light-emitting signal.

2. The transmission cable structure of claim 1, wherein the cable comprises a light-guiding strip installed therein, the light-guiding strip connecting with the light-emitting circuit, and the light-guiding strip extending from the first connector to the second connector.

3. The transmission cable structure of claim 2, wherein the first connector, the cable and the second connector comprise light-transmissible material.

4. The transmission cable structure of claim 1, wherein the control circuit generates the light-emitting signal when the equivalent capacitance value of the conducting wire is greater than a preset capacitance value.

5. The transmission cable structure of claim 2, wherein the control circuit generates the light-emitting signal when the equivalent capacitance value of the conducting wire is greater than a preset capacitance value.

6. The transmission cable structure of claim 1, wherein the control circuit comprises a charging/discharging circuit, a counter and a comparator, the charging/discharging circuit being coupled to the conducting wire, the charging/discharging circuit charging and discharging according to the equivalent capacitance value of the conducting wire, the counter counting a number of charging/discharging times of the charging/discharging circuit to generate a count value, the comparator comparing the count value with a predetermined value to generate the light-emitting signal.

7. The transmission cable structure of claim 2, wherein the control circuit comprises a charging/discharging circuit, a counter and a comparator, the charging/discharging circuit being coupled to the conducting wire, the charging/discharging circuit charging and discharging according to the equivalent capacitance value of the conducting wire, the counter counting a number of charging/discharging times of the charging/discharging circuit to generate a count value, the comparator comparing the count value with a predetermined value to generate the light-emitting signal.

8. The transmission cable structure of claim 1, wherein the first connector connects with a power apparatus via the connecting portion, and the second connector connects with a powered device.

9. The transmission cable structure of claim 2, wherein the first connector connects with a power apparatus via the connecting portion, and the second connector connects with a powered device.

10. The transmission cable structure of claim 1, wherein the first connector connects with a powered device via the connecting portion, and the second connector connects with a power apparatus.

11. The transmission cable structure of claim 2, wherein the first connector connects with a powered device via the connecting portion, and the second connector connects with a power apparatus.

12. The transmission cable structure of claim 1, wherein the light-emitting circuit emits light sustainingly within a preset period, or emits light intermittently within the preset period.

13. The transmission cable structure of claim 2, wherein the light-emitting circuit emits light sustainingly within a preset period, or emits light intermittently within the preset period.
